(19) United States
(12) Patent Application Publication
(10) Pub. No.: US 2021/0245977 A1
(43) Pub. Date: Aug. 12, 2021

(54) PRINT DEVICES

(71) Applicant: Hewlett-Packard Development Company, L.P., Spring, TX (US)

(72) Inventors: Shuang-Kun Zhu, Shanghai (CN); Dean Richtsmeier, Boise, ID (US); Hao-Hua Zhu, Shanghai (CN)

(21) Appl. No.: 15/733,786

(22) PCT Filed: Aug. 22, 2018
(86) PCT No.: PCT/CN2018/101735

§ 371 Date: Oct. 26, 2020

(51) Int. Cl. B65H 3/06; B41J 13/076

(52) U.S. Cl. CPC B65H 3/0638; B41J 13/076; B65H 2801/03; B65H 2404/13163; B65H 2404/1119

(57) ABSTRACT

A print device comprises a media pickup assembly to feed print media, from a print media stack of an input tray, into a media loading path for printing. The media pickup assembly (106) includes a pickup roller (110) mounted on a rotatable shaft (108) and may include an outer surface (112) to be in contact with the print medium and a slot (114) comprising lateral walls (404) extending from the outer surface towards a central longitudinal axis of the pickup roller. Each lateral wall has an edge meeting the outer surface (112). The edge (408) creates a surface contact between the print media and the pickup roller, to allow the pickup roller (110) to push the print media into the media loading path. A distance between the edge (408) of one lateral wall (404-1) and the edge of another lateral wall (404-2) is in a range of about 2 mm to 3 mm. The distance defines a width of the slot (114).

### BACKGROUND

Print devices are peripherals commonly used in home and office environments for obtaining printed copies of digital documents. Print devices may be provided with different print trays for handling print media during a print job. For instance, the print devices may be provided with an input print tray for holding and receiving print media of different sizes and types. The print media is typically stacked in the input tray and fed into a media loading path for printing, by a media pickup assembly of the print device.

### BRIEF DESCRIPTION OF THE DRAWINGS

The detailed description is described with reference to the accompanying figures. It should be noted that the description and figures are merely example of the present subject matter and are not meant to represent the subject matter itself.

FIG. 1 illustrates a block diagram of a print device, according to an example of the present subject matter.

FIG. 2 illustrates a block diagram of a media pickup assembly, according to an example of the present subject matter.

FIG. 3 illustrates a block diagram of an imaging device, according to an example of the present subject matter.

FIG. 4 illustrates a pickup roller of a media pickup assembly, according to an example of the present subject matter.

FIG. 5 illustrates a partial view of print device depicting a media pickup assembly, according to an example of the present subject matter.

### DETAILED DESCRIPTION

Print devices are provided with print trays, such as input trays and an output tray for handling print media during a print job. The input tray may be provided for holding and receiving print media for printing. The print media is typically stacked in the input tray and fed into a media loading path for printing, by a media pickup assembly of the print device. The print media unit includes pickup rollers mounted on a rotatable shaft to push the print media into the media loading path. An outer surface of the pickup roller is usually in contact with the print medium on top of a print media stack. As the rotatable shaft rotates the pickup roller, the print media gets pushed into the media loading path owing to friction created between the pickup roller and a top surface of the print medium on top. Further, in print devices having a slope design, i.e., having the media loading path and print nozzles at a height above the input tray, a higher frictional coefficient may have to be present to push the print media up the slope into the media loading path. The frictional coefficient in such a case may have to be higher than the frictional coefficient desired in print devices having the media loading path at suitable height or having a media lifting component for moving the print media to a print unit having the print nozzles.

However, print media, such as talc media may have an additive, such as talc which may get deposited over the outer surface of the pickup rollers overtime. The talc deposited over the outer surface of the pickup rollers may act as a lubricant and reduce the frictional coefficient of the pickup rollers' outer surface. Owing to the reduced frictional coefficient, the pickup roller may slip over a top surface of the talc media and may thus not be able to push the talc media into the media loading path. For instance, in the print device having the slope design, the pickup roller may not be able to push the talc media or a heavy print media into the media loading path if a threshold frictional coefficient is not realized. The frictional coefficient may further get reduced owing to wear and tear of the pickup roller caused by regular usage over time.

The present subject matter discloses example implementations of a media pickup assembly of a print device. The media pickup assembly is to feed print media from a print media stack, into a media loading path for printing. The media pickup assembly includes a pickup roller having an outer surface to be in contact with the print medium on top of the print media stack, for pushing the print medium into the media loading path. In one example implementation, the pickup roller includes a slot on the outer surface to increase a contacting area between the pickup roller and the print medium, thereby, increasing frictional coefficient between the pickup roller and the print medium. The pickup roller may thus efficiently push the print media into the media loading path.

In one example implementation, the print device may include an input tray to receive a print media stack for printing and the media pickup assembly to manage print media feed, from the input tray, into the media loading path for printing. The media pickup assembly may include pickup rollers mounted on a rotatable shaft to pick up the print medium from the input tray. Each of the pickup roller may include the slot on the outer surface of the pickup roller. In one example implementation of the present subject matter, each slot includes lateral walls extending from the outer surface towards a central longitudinal axis of the pickup roller. In one example, each slot includes two lateral walls, with each lateral wall having an edge meeting the outer surface of the pickup roller. In one example, the edge of each lateral wall creates a surface contact between the print media and the pickup roller when the edge comes in contact with the top surface of the print media. Creating the contact surface allows the pickup roller to push the print media into the media loading path.

In one example, the width of the slot is kept below a predetermined value such that edges of both the lateral walls simultaneously comes in contact with the print media, thereby increasing the contact area and the frictional coefficient between the pickup roller and the print media. In one example implementation of the present subject matter, the width of the slot is defined by a distance between the edge of one lateral wall to the edge of another lateral wall of the slot and is in a range of about 2 millimeter (mm) to 3 mm. Further, a depth of the slot is defined by a height of each lateral wall, measured from a base to the edge, and is in a range of about 0.5 mm to 1 mm.

The present subject matter, may thus facilitate in increasing the area of surface contact between the pickup roller and the print media, thereby increasing the frictional coefficient and force between the pickup roller and the print media. The increased frictional force may allow the pickup roller to push print media such as talc media and heavy media into the media loading path for all print devices including print devices having a slope design for the media loading path.

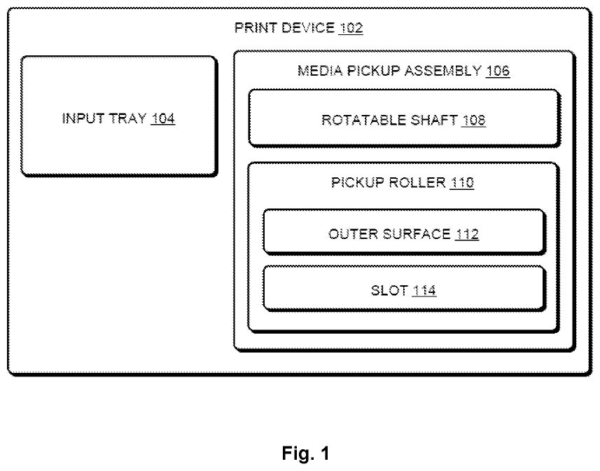

FIG. 1 illustrates a block diagram of a print device 102, according to an example implementation of the present subject matter. The print device 102 may be used for printing documents on a print medium, such as paper. Examples of the print device 102 include, but are not limited to, a printer, a multifunction printer, a home printer, and an office printer. In accordance to an example implementation of the present subject matter, the print device 102 includes an input tray 104 to receive a print media stack for printing.

The print device 102 may further include a media pickup assembly 106 to feed print media from the print media stack, into a media loading path for printing. The media pickup assembly 106 may include a rotatable shaft 108 and a pickup roller 110 mounted on the rotatable shaft 108 to push the print media into the media loading path. Further, the pickup roller 110 may include an outer surface 112 to be in contact with the print medium on top of the print media stack. The print medium may be provided for being fed into the media loading path. The pickup roller 110 may further include a slot 114 comprising lateral walls extending from the outer surface 112 towards a central longitudinal axis of the pickup roller 110.

In one example, each lateral wall may have an edge meeting the outer surface 112 of the pickup roller 110. The edge of each lateral wall may thus create a surface contact between the print media and the pickup roller 110, to allow the pickup roller 110 to push the print media into the media loading path. In one example implementation, a distance between the edge of one lateral wall to the edge of another lateral wall of the slot 114 may be in a range of about 2 millimeter (mm) to 3 mm. The distance between the edges of the lateral walls defining a width of the slot 114.

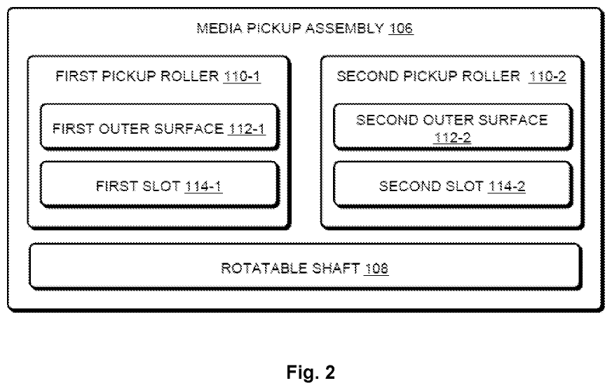

FIG. 2 illustrates a block diagram of the media pickup assembly 106, according to an example implementation of the present subject matter. In accordance to an example implementation of the present subject matter, media pickup assembly 106 may be implemented in printing and scanning device, such as a print device 102 and an imaging device. The media pickup assembly 106 includes the rotatable shaft 108 and the pickup rollers, such as the pickup roller 110 mounted on the rotatable shaft 108. In one example implementation, the media pickup assembly 106 includes a first pickup roller 110-1 and a second pickup roller 110-2.

The first pickup roller 110-1 may be mounted on the rotatable shaft 108 to push the print media into the media loading path for printing. The first pickup roller 110-1 may include a first outer surface 112-1 to be in contact with the print medium on top of the print media stack and a first slot 114-1 provided on the first outer surface 112-1. The second pickup roller 110-2 may be mounted on the rotatable shaft 108 to push the print media into the media loading path for printing. The second pickup roller 110-2 may include a second outer surface 112-2 to be in contact with the print medium on top of the print media stack and a second slot 114-2 provided on the second outer surface 112-2. The first pickup roller 110-1 and the second pickup roller 110-2 are hereinafter collectively referred to as pickup rollers 110 and individually referred to as pickup roller 110. The first outer surface 112-1 and the second outer surface 112-2 are hereinafter collectively referred to as outer surface 112 and individually referred to as outer surface 112. The first slot 114-1 and the second slot 114-2 are hereinafter collectively referred to as slots 114 and individually referred to as slot 114.

In one example, each of the first slot 114-1 and the second slot 114-2 may include lateral walls extending from the corresponding outer surface 112 towards a central longitudinal axis of the corresponding pickup roller 110. Each lateral wall may have an edge meeting the outer surface 112 of the corresponding pickup roller 110 such that the edge of each lateral wall creates a contact surface between the print media and the corresponding pickup roller 110. Further, each lateral wall has a height measured from a base to the edge in a range of about 0.5 mm to 1 mm. The height of each lateral wall defining a depth of the slot 114.

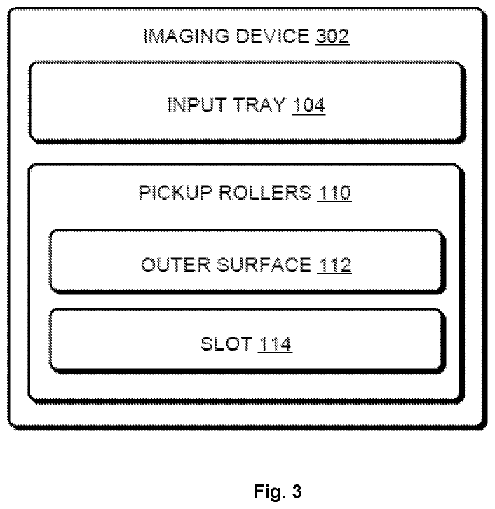

FIG. 3 illustrates a block diagram of an imaging device 302, according to an example implementation of the present subject matter. Examples of the imaging device 302 include, but are not limited to, printers, multi-functional printers, scanners, etc. In one example, the imaging device 302 includes the input tray 104 and pickup rollers 110. The input tray 104 is to receive a print media stack for printing. The pickup rollers 110 are to push print media from the print media stack into the media loading path for printing.

In one example, each pickup roller 110 may include the outer surface 112 and the slot 114. The outer surface 112 may come in contact with a print medium on top of the print media stack when the print medium is being fed into the media loading path for printing. Further, the slot 114 may include lateral walls extending from the outer surface 112 towards the central longitudinal axis of the pickup roller 110. In one example, each lateral wall may have an edge meeting the outer surface 112 of the pickup roller 110. The edge of each lateral wall may create a contact surface between the print medium and the pickup roller 110 when the slot 114 and the print media come in contact, to allow the pickup roller 110 to push the print media into the media loading path.

In one example implementation, a depth of the slot 114 may be defined by a height of the lateral wall, while a width of the slot 114 may be defined by a distance between two lateral walls. In one example, each lateral wall may have the height measured from a base to the edge in a range of about 0.5 mm to 1 mm. Further, the distance between the edge of one lateral wall to the edge of another lateral wall of the slot 114 may be in a range of about 2 mm to 3 mm.

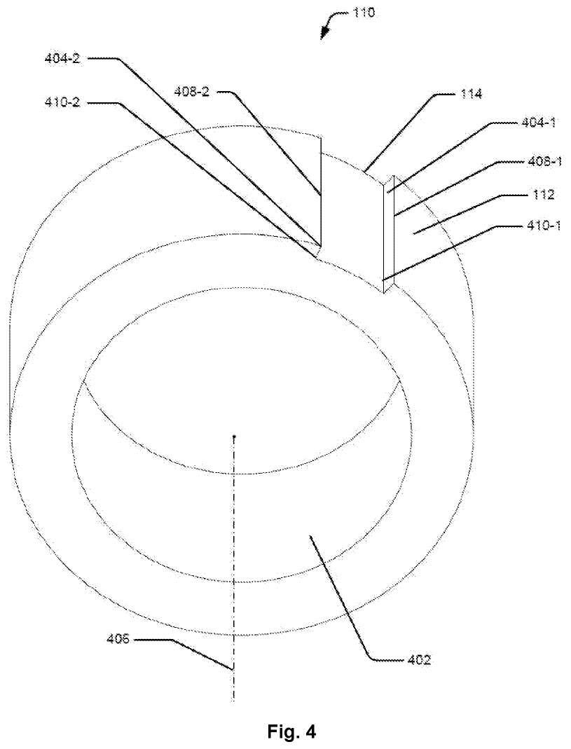

FIG. 4 illustrates the pickup roller 110 of the media pickup assembly 106, according to an example of the present subject matter. As previously described, the pickup roller 110 may be implemented in the media pickup assembly 106 of an imaging device, such as the imaging device 302. Examples of the imaging device 302 include, but are not limited to, multi-functional print devices, scanners, and print devices, such as print device 102. In one example, the pickup roller 110 may be the first pickup roller 110-1 of the media pickup assembly 106. In another example, the pickup roller 110 may be the second pickup roller 110-2 of the media pickup assembly 106. In one example, the pickup roller 110 may be made from ethylene-propylene-diene monomer.

In one example implementation, the pickup roller 110 may include an inner surface 402, the outer surface 112, and the slot 114. The inner surface 402 may be the surface in contact with the rotatable shaft 108. The outer surface 112 may be the surface that may come in contact with the print media being fed into the print medium path from the input tray 104. In one example, the print media may include, but is not limited to a talc media, a heavy print media, a super heavy print media etc. The talc media may have an additive, such as talc that may get deposited over the outer surface 112 over time. The heavy print media is a print media having a weight in the range of about 90 grams (g) to 120 g. The extra print media is a print media having a weight above 120 g.

The slot 114 may be provided on the outer surface 112 to create an increased surface area of contact between the print media and the pickup roller 110. In one example, the slot 114 may include two lateral walls 404, such as a first lateral wall 404-1 and a second lateral wall 404-2, defining the slot 114 in the outer surface 112. The lateral walls 404 may vertically extend from the outer surface 112 towards a central longitudinal axis 406 of the pickup roller 110. The central longitudinal axis 406 may be a longest longitudinal axis passing through a centre of the pickup roller 110. For instance, the first lateral wall 404-1 may extend from a first edge 408-1 to a first base 410-1. The second lateral wall 404-2 may extend from a second edge 408-2 to a second base 410-2. The first edge 408-1 and the second edge 408-2 are hereinafter collectively referred to as edges 408 and individually referred to as edge 408. The first base 410-1 and the second base 410-2 are hereinafter collectively referred to as base 410 and individually referred to as base 410. Further, the lateral walls 404 may horizontally extend across a width of the pickup roller 110, defining a length of the longitudinal walls 404.

In one example implementation, a depth of the slot 114 may be defined by a height of the lateral walls 404, the width of the slot 114 may be defined by a distance between the two lateral walls 404, and a length of the slot 114 may be defined by the length of the lateral walls 404. In one example, length of the slot 114 may be equal to the width of the pickup roller 110.

In one example, the height of each of the lateral walls 404 may be measured from the edge 408 to the base 410 of the lateral wall 404 and may be in a range of about 0.5 mm to 1 mm. The slot 114 may thus have the depth in the range of about 0.5 mm to 1 mm. Further, the distance between the two lateral walls 404 may be determined as a distance between the edges 408 of the lateral walls 404. For instance, for the first pickup roller 110-1, the distance between the first edge 408-1 of the first lateral wall 404-1 to the second edge 408-2 of the second lateral wall 404-2 is in the range of about 2 mm to 3 mm. The slot 114 may thus have the width in the range of about 2 mm to 3 mm.

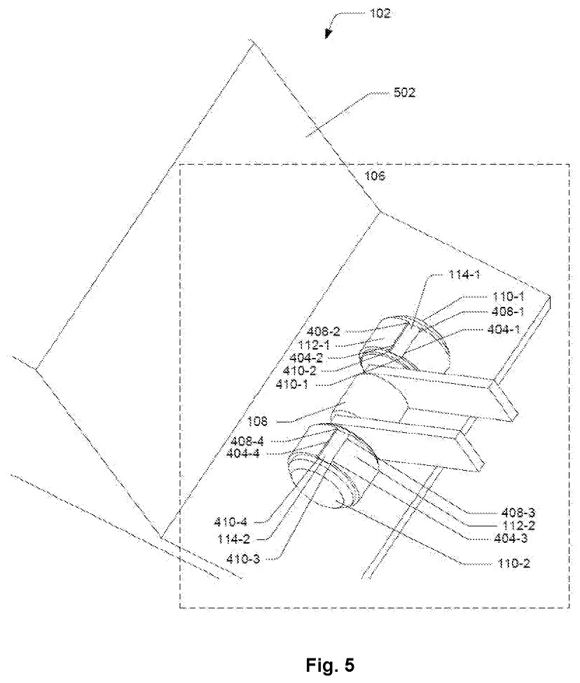

In one example implementation, the slot 114 may have a width of 2.5 mm and a depth of 0.5 mm. In another example implementation, the slot 114 may have a width of 2.25 mm and a depth of 0.5 mm. In another example implementation, the slot 114 may have a width of 2 mm and a depth of 0.5 mm. In one example implementation, the slot 114 may have a width of 2.75 mm and a depth of 0.5 mm. In another example implementation, the slot 114 may have a width of 3 mm and a depth of 0.5 mm. In another example implementation, the slot 114 may have a width of 2.25 mm and a depth of 0.75 mm. In another example implementation, the slot 114 may have a width of 2.5 mm and a depth of 0.75 mm. In another example implementation, the slot 114 may have a width of 2.75 mm and a depth of 0.75 mm. In another example implementation, the slot 114 may have a width of 3 mm and a depth of 0.75 mm. In another example implementation, the slot 114 may have a width of 2 mm and a depth of 0.75 mm. In another example implementation, the slot 114 may have a width of 2.25 mm and a depth of 1 mm. In another example implementation, the slot 114 may have a width of 2.5 mm and a depth of 1 mm. In another example implementation, the slot 114 may have a width of 2.75 mm and a depth of 1 mm. In another example implementation, the slot 114 may have a width of 3 mm and a depth of 1 mm. In another example implementation, the slot 114 may have a width of 2 mm and a depth of 1 mm. The working of the pickup roller 110 is further explained while describing FIG. 5.

FIG. 5 illustrates a partial view of the print device 102 depicting the media pickup assembly 106, according to an example of the present subject matter. As previously described, the media pickup assembly 106 may include the rotatable shaft 108 and the pickup up rollers 110 mounted on the rotatable shaft 108. In one example implementation of the present subject matter, the media pickup assembly 106 may include two pickup rollers, the first pickup roller 110-1 and the second pickup roller 110-2. The first pickup roller 110-1 and the second pickup roller 110-2 may be mounted on a first side and a second side, respectively, of the rotatable shaft 108, with respect to a center of a width of the print media being loaded in the media loading path.

The first pickup roller 110-1 may include the first outer surface 112-1 and the first slot 114-1 extending from the first outer surface 112-1 towards the central longitudinal axis 406 of the pickup roller 110. Further, the first slot 114-1 may include the first lateral wall 404-1 and the second lateral wall 404-2 opposite to the first lateral wall 404-1. In one example, both the first lateral wall 404-1 and the second lateral wall 404-2 extend from the first outer surface 112-1 towards the central longitudinal axis 406. In one example, the first lateral wall 404-1 may include the first edge 408-1 and the first base 410-1. The second lateral wall 404-2 may include the second edge 408-2 and the second base 410-2. Further, height of the first lateral wall 404-1 and the second lateral wall 404-2 may be in the range of about 0.5 mm to 1 mm. The first slot 114-1 may thus have the depth in the range of about 0.5 mm to 1 mm. Further, the distance between the first edge 408-1 of the first lateral wall 404-1 and the second edge 408-2 of the second lateral wall 404-2 is in the range of about 2 mm to 3 mm. The first slot 114-1 may thus have the width in the range of about 2 mm to 3 mm.

The second pickup roller 110-2 may include the second outer surface 112-2 and the second slot 114-2 extending from the second outer surface 112-2 towards the central longitudinal axis 406 of the pickup roller 110. Further, the second slot 114-2 may include a third lateral wall 404-3 and a fourth lateral wall 404-4 opposite to the third lateral wall 404-3. In one example, both the third lateral wall 404-3 and the fourth lateral wall 404-4 extend from the second outer surface 112-2 towards the central longitudinal axis 406. In one example, the third lateral wall 404-3 may include a third edge 408-3 and a third base 410-3. The fourth lateral wall 404-4 may include the fourth edge 408-4 and the fourth base 410-4. Further, height of the third lateral wall 404-3 and the fourth lateral wall 404-4 may be in the range of about 0.5 mm to 1 mm. The second slot 114-2 may thus have the depth in the range of about 0.5 mm to 1 mm. Further, the distance between the third edge 408-3 of the third lateral wall 404-3 and the fourth edge 408-4 of the fourth lateral wall 404-4 is in the range of about 2 mm to 3 mm. The second slot 114-2 may thus have the width in the range of about 2 mm to 3 mm.

The first lateral wall 404-1, the second lateral wall 404-2, the third lateral wall 404-3, and the fourth lateral wall 404-4 are hereinafter collectively referred to as lateral walls 404 and individually referred to as lateral wall 404. The first edge 408-1, the second edge 408-2, the third edge 408-3, and the fourth edge 408-4 are hereinafter collectively referred to as edges 408 and individually referred to as edge 408. The first base 410-1, the second base 410-2, the third base 410-3, and the fourth base 410-4 are hereinafter collectively referred to as base 410 and individually referred to as base 410.

As previously described, the pickup rollers 110 may be mounted on the rotatable shaft 108 and implemented in the media pickup assembly 106 to feed print media from the input tray 104 to a media loading path 502. In operation, as the print device 102 receives a print command, the rotatable shaft 108 may rotate, thereby, rotating the pickup rollers 110 to push a print medium, from the top of the print media stack in the input tray 104, into the media loading path 502. The rotatable shaft 108 may rotate the pickup rollers 110 such that the slots 114 come in contact with the top surface of the print medium. As the slots 114 come in contact with the top surface of the print medium, the two edges 408 of the slot 114 may simultaneously come in contact with the print medium to create a surface contact between the print medium and the pickup roller 110. For instance, for the first slot 114-1, the first edge 408-1, and the second edge 408-2 may come in contact with the print medium at the same time, to create the surface contact. In one example, as the slot 114 comes in contact with the print medium, the edges 408 elastically stretch due to pressure thereby increasing the area under surface contact with the print medium. The friction caused between the increased area of surface contact may cause the print medium, such as the talc media to move forward and upward into the media loading path 502 for printing. Further, upon completion of each rotation, the edges 408 of the lateral walls 404 of the slot 114 come in contact with the print medium on top of the print media stack.

In one example, during operation, the rotatable shaft 108 may rotate the first pickup roller 110-1 and the second pickup roller 110-2 such that the first slot 114-1 of the first pickup roller 110-1 and the second slot 114-2 of the second pickup roller 110-2 alternately come into contact with the print medium. For instance, the first pickup roller 110-1 and the second pickup roller 110-2 may be mounted on the rotatable shaft 108 such that at one time, a single slot 114 of one of the pickup rollers 110 comes in contact with a first part of the print medium, pushing forward the print medium. As the rotatable shaft 108 further rotates, the other slot 114 may come in contact with a second part of the print medium to further push the print medium forward.

In another example, during operation, the first slot 114-1 of the first pickup roller 110-1 and the second slot 114-2 of the second pickup roller 110-2 are to simultaneously come into contact with the print medium by rotation of the rotatable shaft 108. Thus, the first pickup roller 110-1 and the second pickup roller 110-2 may be mounted on the rotatable shaft 108 such both the slots 114 together come in contact with a first part of the print medium, pushing forward the print medium into the media loading path.

Although examples for the present subject matter have been described in language specific to structural features and/or methods, it should be understood that the appended claims are not limited to the specific features or methods described. Rather, the specific features and methods are disclosed and explained as examples of the present subject matter.

1. A print device comprising:
an input tray to receive a print media stack for printing; and
a media pickup assembly to feed print media from the print media stack, into a media loading path for printing, the media pickup assembly comprising a pickup roller mounted on a rotatable shaft to push the print media into the media loading path, the pickup roller comprising:
an outer surface to be in contact with the print medium on top of the print media stack, for being fed into the media loading path; and
a slot comprising lateral walls extending from the outer surface towards a central longitudinal axis of the pickup roller, each lateral wall having an edge meeting the outer surface of the pickup roller, wherein the edge of each lateral wall is to create a surface contact between the print media and the pickup roller, to allow the pickup roller to push the print media into the media loading path, and wherein a distance between the edge of one lateral wall to the edge of another lateral wall of the slot is in a range of about 2 millimeter (mm) to 3 mm, the distance defining a width of the slot.

2. The print device as claimed in claim 1, wherein each lateral wall has a height measured from a base to the edge in a range of about 0.5 mm to 1 mm, the height defining a depth of the slot.

3. The print device as claimed in claim 1, wherein the pickup roller is made from ethylene-propylene-diene monomer.

4. The print device as claimed in claim 1, wherein the rotatable shaft is to rotate the pickup roller to push the print media into the media loading path, and wherein upon completion of each rotation, the edge of a first lateral wall of the slot comes in contact with the print media on top of the print media stack.

5. The print device as claimed in claim 1, wherein the lateral walls comprise a first lateral wall and a second lateral wall opposite to the first lateral wall.

6. The print device as claimed in claim 1, wherein the slot has a length equal to a width of the pickup roller.

7. A media pickup assembly comprising:
a first pickup roller mounted on a rotatable shaft to push print media into a media loading path for printing, the first pickup roller comprising:
a first outer surface to be in contact with the print medium on top of the print media stack; and
a first slot provided on the first outer surface; and
a second pickup roller mounted on the rotatable shaft to push the print media into the media loading path for printing, the second pickup roller comprising:
a second outer surface to be in contact with the print medium on top of the print media stack; and
a second slot provided on the second outer surface;
wherein each of the first slot and the second slot comprising:
lateral walls extending from the corresponding outer surface towards a central longitudinal axis of the corresponding pickup roller, each lateral wall having an edge meeting the outer surface of the corresponding pickup roller, wherein the edge of each lateral wall is to create a contact surface between the print media and the corresponding pickup roller, and wherein each lateral wall has a height measured from a base to the edge in a range of about 0.5 millimeter (mm) to 1 mm, the height defining a depth of the slot.

8. The media pickup assembly as claimed in claim 7, wherein the first slot includes a first lateral wall and a second lateral wall extending from the first outer surface towards the central longitudinal axis of the first pickup roller, and wherein a distance between a first edge of the first lateral wall to a second edge of the second lateral wall of the first slot is in a range of about 2 mm to 3 mm, the distance defining a width of the first slot.

9. The media pickup assembly as claimed in claim 7, wherein the second slot includes a third lateral wall and a fourth lateral wall extending from the second outer surface towards the central longitudinal axis of the second pickup roller, and wherein a distance between a third edge of the third lateral wall to a fourth edge of the fourth lateral wall of the second slot is in a range of about 2 mm to 3 mm, the distance defining a width of the second slot.

10. The media pickup assembly as claimed in claim 7, wherein the first pickup roller and the second pickup roller are mounted on a first side and a second side, respectively, of the rotatable shaft with respect to a center of a width of the print media.

11. The media pickup assembly as claimed in claim 10, wherein the first slot of the first pickup roller and the second slot of the second pickup roller are to alternately come into contact with the print medium by rotation of the rotatable shaft.

12. The media pickup assembly as claimed in claim 10, wherein the first slot of the first pickup roller and the second slot of the second pickup roller are to simultaneously come into contact with the print medium by rotation of the rotatable shaft.

13. An imaging device comprising:
an input tray to receive a print media stack for printing; and
pickup rollers to push print media from the print media stack into a media loading path for printing, each of the pickup rollers comprising:
an outer surface to be in contact with a print medium on top of the print media stack, for being fed into the media loading path; and
a slot comprising lateral walls extending from the outer surface towards a central longitudinal axis of the pickup roller, each lateral wall having an edge meeting the outer surface of the pickup roller, wherein the edge of each lateral wall is to create a contact surface between the print medium and the pickup roller, to allow the pickup roller to push the print media into the media loading path, and wherein each lateral wall has a height measured from a base to the edge in a range of about 0.5 millimeter (mm) to 1 mm, and wherein a distance between the edge of one lateral wall to the edge of another lateral wall of the slot is in a range of about 2 mm to 3 mm, the height defining a depth of the slot and the distance defining a width of the slot.

14. The imaging device as claimed in claim 13, wherein the imaging device comprises a media pickup assembly to feed the print media from the print media stack, into the media loading path for printing, the media pickup assembly comprising:
a rotatable shaft; and
the pickup rollers mounted on the rotatable shaft, wherein a first pickup roller, from among the pickup rollers, and a second pickup roller, from among the pickup rollers, are mounted on a first side and a second side, respectively, of the rotatable shaft with respect to a center of a width of the print media.

15. The imaging device as claimed in claim 13, wherein each slot has a length equal to a width of the corresponding pickup roller.
